(19) United States
(12) Patent Application Publication
(10) Pub. No.: US 2009/0022535 A1
(43) Pub. Date: Jan. 22, 2009

(54) DUAL OPPOSED PRINT HEAD ENVELOPE PRINTER

(75) Inventor: Edward F. Hampton, Woodbury, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Inc., Stamford, CT (US)

(21) Appl. No.: 11/779,525

(22) Filed: Jul. 18, 2007

(51) Int. Cl. B41J 1/50

(52) U.S. Cl. 400/149

(57) ABSTRACT

According to some embodiments, a method is provided. The method comprises printing a return address on a mail piece, and printing a destination address on the mail piece. A first print head assembly prints the return address and a second print head assembly prints the destination address. At least part of the return address is printed simultaneously with at least part of the destination address. The first print head assembly prints in a first direction and the second print head assembly prints in a second direction, where the first direction is opposite of the second direction.

### BACKGROUND

One source of delay in mass mailings is the physical act of printing addresses and return addresses on a plurality of mail pieces, such as envelopes. Envelope printers typically print in one direction. For example, a printer may start at a top left-most portion of an envelope and may stop printing at a bottom right-most portion.

Incremental changes in methods of printing that result in increased envelope throughput may result in significant time savings for a print job that may consist of tens of thousands of mail pieces. Methods of printing that may increase productivity may include a parallel printing path implemented with multiple printers. This however requires more physical real estate, generates more heat, and requires more power. It also requires the mailing list to be divided and sent to multiple printers. Dividing a print stream into multiple separate print streams may be complicated for non-text based print data. Commands that set up the printer to print a job usually appear at the head of a file, so dividing the print job into separate streams without extracting the setup commands may result in only one printer being correctly set up. Also, font data, once defined, may not typically be defined again later in the file, so unless the setup commands are extracted and sent to multiple printers, only one printer will have the font defined.

### SUMMARY OF THE INVENTION

In some embodiments, a method is disclosed. The method comprises printing a return address on a mail piece and printing a destination address on the mail piece. A first print head assembly prints the return address and a second print head assembly prints the destination address. At least part of the return address is printed simultaneously with at least part of the destination address. The first print head assembly prints in a first direction and the second print head assembly prints in a second direction where the first direction is opposite of the second direction.

In some embodiments a printer is disclosed. The printer comprises a first pulley, a second pulley, a first guide shaft, a second guide shaft, a drive belt coupled to and pulled by the first pulley and the second pulley, a first print head assembly, and a second print head assembly. The drive belt forms a loop when coupled to the first pulley and the second pulley, and the first print head assembly is coupled to a first portion of the loop, and the second print head assembly is coupled to a second portion of the loop. When the drive belt is pulled, the first print head assembly prints in a first direction and the second print head assembly prints in a second direction.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, descriptions, and claims.

### BRIEF DESCRIPTION OF THE DRAWINGS

The accompanying drawings illustrate presently preferred embodiments of the invention and, together with the general description given above and the detailed description given below, serve to explain the principles of the invention. As shown throughout the drawings, like reference numerals designate like or corresponding parts.

FIG. 1 illustrates a printer according to some embodiments.

FIG. 2 illustrates a system according to some embodiments.

FIG. 3 illustrates a mail piece according to some embodiments.

FIG. 4 illustrates a printer according to some embodiments.

FIG. 5 illustrates a method according to some embodiments.

FIG. 6 is a system diagram showing printer 100 of FIG. 1 being coupled to an inserter.

### DETAILED DESCRIPTION OF THE INVENTION

The several embodiments described herein are provided solely for the purpose of illustration. Embodiments may include any currently or hereafter-known versions of the elements described herein. Therefore, persons in the art will recognize from this description that other embodiments may be practiced with various modifications and alterations.

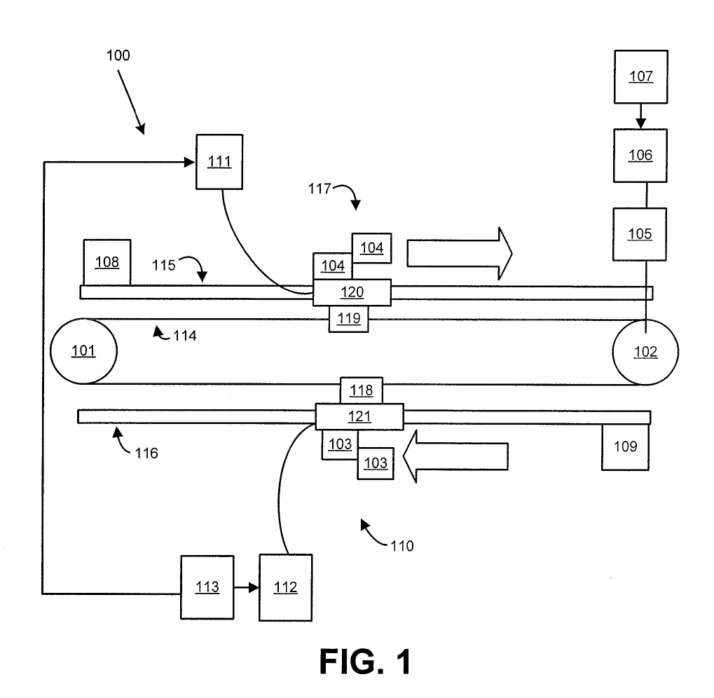

Now referring to FIG. 1, an embodiment of a printer 100 is illustrated. The printer 100 may comprise a first pulley 101, a second pulley 102, a shuttle motor 105, an encoder 106, a microprocessor drive assembly 107, a first capping station 108, a second capping station 109, a first print head assembly 110, a second print head assembly 117, a first print buffer 111, a second print buffer 112, a print buffer controller 113, a drive belt 114, a first guide shaft 115, and a second guide shaft 116. In some embodiments, a print head assembly may be synonymous with a print head.

The first print head assembly 110 may comprise a plurality of print cartridges 103. In some embodiments, the first print head assembly 110 may comprise a single print cartridge 103 or may comprise two or more cartridges 103 that are offset from each other. By offsetting each print cartridge 103, more surface area may be printed by the print head assembly 110 at a given time. The first print head assembly 110 may further comprise a first guide shaft coupling 121 to couple the first print head assembly 110 to the first guide shaft 116, and a first drive belt coupling 118 to couple the first print head assembly 110 to the drive belt 114.

The second head assembly 117, like the first print head assembly 110, may comprise similar elements such as, a second plurality of print cartridges 104, a second guide shaft coupling 120 to couple the second print head assembly 117 to the second guide shaft 119, and a second drive belt coupling 119 to couple the second print head assembly 117 to the drive belt 114.

The drive belt 114 may form a loop when coupled to the first pulley 101 and the second pulley 102 and in some embodiments, the drive belt 114 may be comprised of plastic, rubber, or metal. The first print head assembly 110 may be coupled to a first portion of the loop and the second print head assembly 117 is coupled to a second portion of the loop. When the drive belt 114 is pulled, pushed, turned, or rotated, the first print head assembly 110 may print and/or move in a first direction and the second print head assembly 117 may print and/or move in a second direction. In some embodiments, the first direction may be opposite of the second direction. While printing and/or moving, each print head assembly 110/117 may move along its respective guide shaft 116/115.

In some embodiments, one pulley may be a drive pulley and another pulley may rotate when the drive pulley pulls the drive belt 114. In the illustrated example, the first pulley 101 may just rotate and the second pulley may 102 be a drive pulley. The second pulley 102 may be driven by the shuttle motor 105 that receives position information from the encoder 106 and the microprocessor drive assembly 107 is known in the art. In some embodiments, the control of the printer 100 may be a closed-loop control system. In some embodiments, the shuttle motor 105 may be closed loop direct current (“DC”) motor or a stepper motor.

In some embodiments, each print head assembly 110/117 may comprise one or more inkjet cartridges 103 and may require a capping station 108/109 to cap each cartridge associated with each print head assembly. Each ink cartridge 103 may be coupled to and supply ink to a respective print head assembly. As illustrated in FIG. 1, a first capping station 109 is coupled to the first guide shaft 116 and a second capping station 108 is coupled to the second guide shaft 115.

Each print head assembly 110/117 may independently receive data from an associated print buffer 111/112. For example, the first print head assembly 110 may receive data from a first print buffer 112 and the second print head assembly 117 may receive data from a second print buffer 111. A print buffer controller 113 may control each print buffer 111/112 and the print buffer controller 113 may send data to each print buffer 111/112. For example, the print buffer controller 113 may send a destination address to the first print buffer 112 and may send a return address to the second print buffer 111.

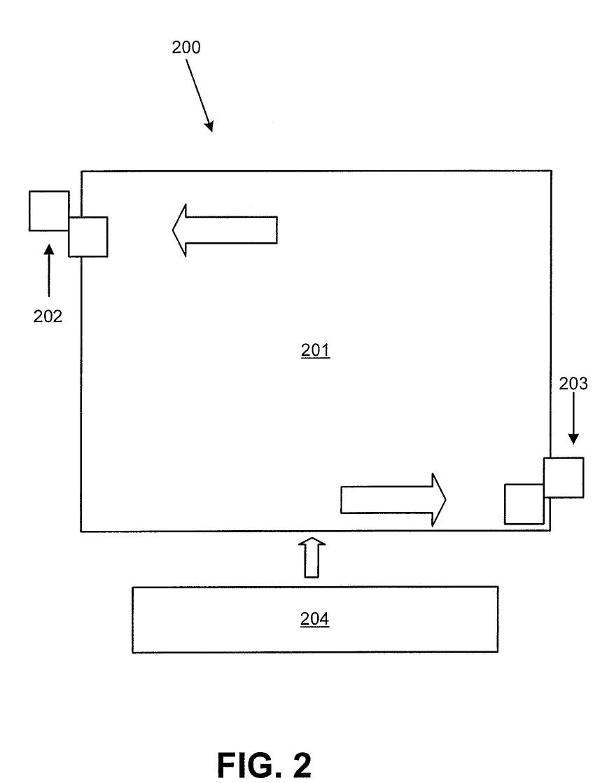

Now referring to FIG. 2, an embodiment of a system 200 is illustrated. System 200 may comprise an envelope 201, a printer comprising a first print head 202, the first print head including a first plurality of print cartridges, a second print head 203, the second print head including a second plurality of print cartridges, and an envelope feeder 204.

The envelope feeder 204 may feed envelopes toward the first print head 202 and the second print head 203. The feed direction of the envelope feeder may be orthogonal to the direction (e.g. shuttle travel) of the first print head 202 and the second print head 203. In some embodiments, the envelope feeder may feed at least 10,000 envelopes per hour to the printer. In some embodiments, the envelope feeder may feed over 13,000 envelopes per hour to the printer.

As illustrated in FIG. 2, when an envelope 201 is fed from the envelope feeder to the printer, the first print head 202 may print information on the envelope in a first direction and the second print head 203 may print information on the envelope in a second direction.

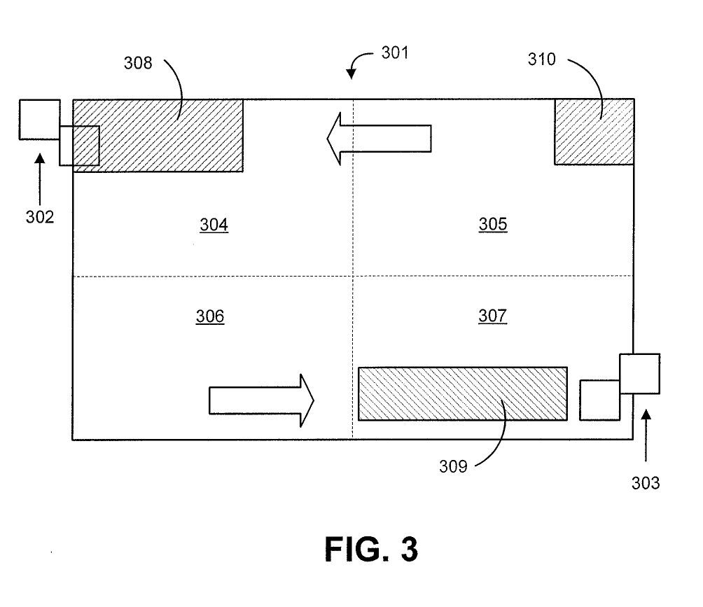

In FIG. 3, a mail piece 301 such as the envelope 201 may be comprised of four quadrants and, as illustrated, the mail piece 301 may be comprised of an upper left quadrant 304, an upper right quadrant 305, a lower left quadrant 306, and a lower right quadrant 307. A return address 308 may be printed in an upper left quadrant of a front face of the mail piece 301 and a destination address 309 may be printed at least in part in a lower right quadrant of a front face of the mail piece 301. At least part of the return address 308 may be printed simultaneously with at least part of the destination address 309 by a first print head 302 and a second print head 303 respectively. Print heads 302 and 303 may be as described with respect to FIG. 1 and FIG. 2. In some embodiments, a postage indicia 310 may be printed via the first print head 302 on the envelope simultaneously with at least part of the destination address 309.

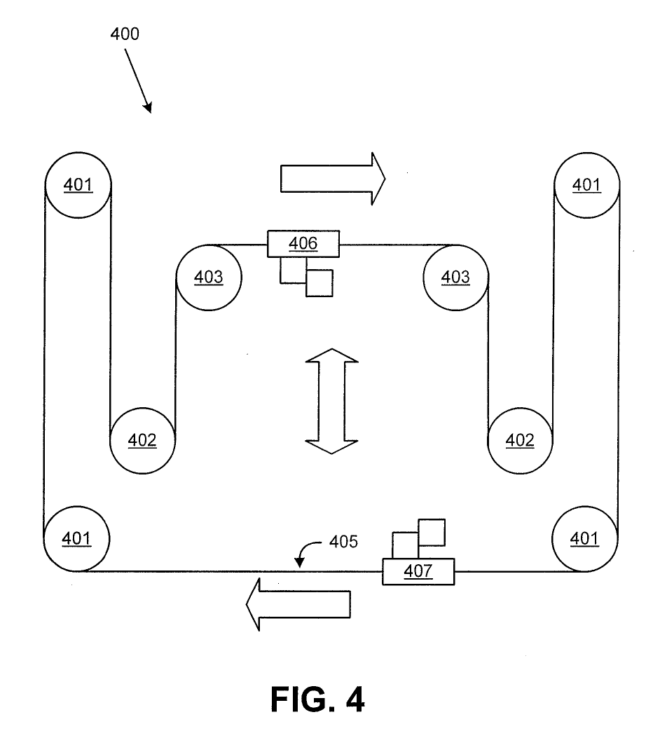

Now referring to FIG. 4, an embodiment of a printer 400 is illustrated. Printer 400 may comprise a first plurality of pulleys 401, a second plurality of pulleys 402, and a third plurality of pulleys 403. The first plurality of pulleys 401 may be fixed-position pulleys that are stationary. The second plurality of pulleys 402 may be adjustable pulleys and the third plurality of pulleys 403 may be adjustable pulleys. A drive belt 405 may loop around all three sets of pulleys 401/402/403.

A first print head 406 may be coupled to a first portion of the drive belt 405 and a second print head 406 may be coupled to a second portion of the drive belt 405. The first print head 406 may print in a first direction and the second print head 407 may print in a second direction, where the first direction is opposite of the second direction. Changing a position of the second plurality of pulleys 402 and/or changing a position of the third plurality of pulleys 403 may adjust a distance between the first print head 406 and the second print head 407. By changing the position of the two pluralities of pulleys 402/403, different sized mail pieces may be fed into the printer 400. For example, the printer may be able to print on a size A-1 envelope (e.g. 3⅝″×5⅛″), No. 10 envelope (e.g. 4⅛×9½), a size A-10 envelope (e.g. 6″×9½″), or any other sized mail piece.

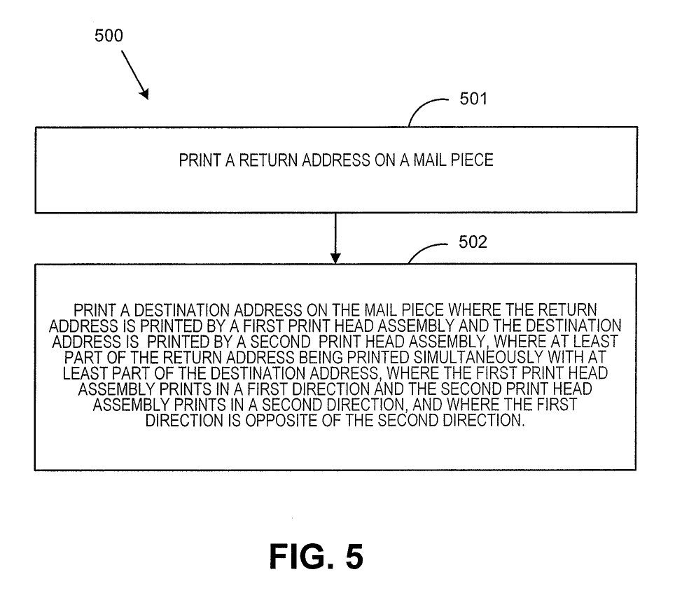

Now referring to FIG. 5, an embodiment of a method 500 is illustrated. Method 500 may be implemented by any printer or printer system, such as, but not limited to, system 200 of FIG. 2, printer 100 of FIG. 1, or printer 400 of FIG. 4.

At 501, a return address is printed on a mail piece. The return address may be printed at an upper left quadrant of a front face of the mail piece. In some embodiments a postage indicia may be printed on the mail piece, where the postage indicia is printed simultaneously with at least part of the destination address. The postage indicia and the return address may be printed by a first print head. In some embodiments, the postage indicia is printed subsequent to the printing of the return address and in some embodiments the return address is printed subsequent to the printing the postage indicia.

At 502, a destination address is printed on the mail piece. The destination address may be printed at least in part in a lower right quadrant of the front face of the mail piece. The return address may be printed by a first print head assembly and the destination address may be printed by a second print head assembly, and at least part of the return address may be printed simultaneously with at least part of the destination address. The first print head assembly may print in a first direction and the second print head assembly may print in a second direction, where the first direction is opposite of the second direction.

The first print head assembly may be pulled in the first direction by using a drive belt wound around a first pulley and a second pulley while guiding the first print head assembly with a first guide shaft. The second print head assembly may be pulled in the second direction by using the drive belt wound around the first pulley and the second pulley while guiding the second print head assembly with a second guide shaft.

In some embodiments, the first print head assembly may comprise a first print cartridge and a third print cartridge that is offset from the first print cartridge, a first guide shaft coupling to couple the first print head assembly to the first guide shaft, and a first drive belt coupling to couple the first print head assembly to the drive belt.

In some embodiments, the second print head assembly may comprise a second print cartridge and a fourth print cartridge that is offset from the second print cartridge, a second guide shaft coupling to couple the second print head assembly to the second guide shaft, and a second drive belt coupling to couple the second print head assembly to the drive belt.

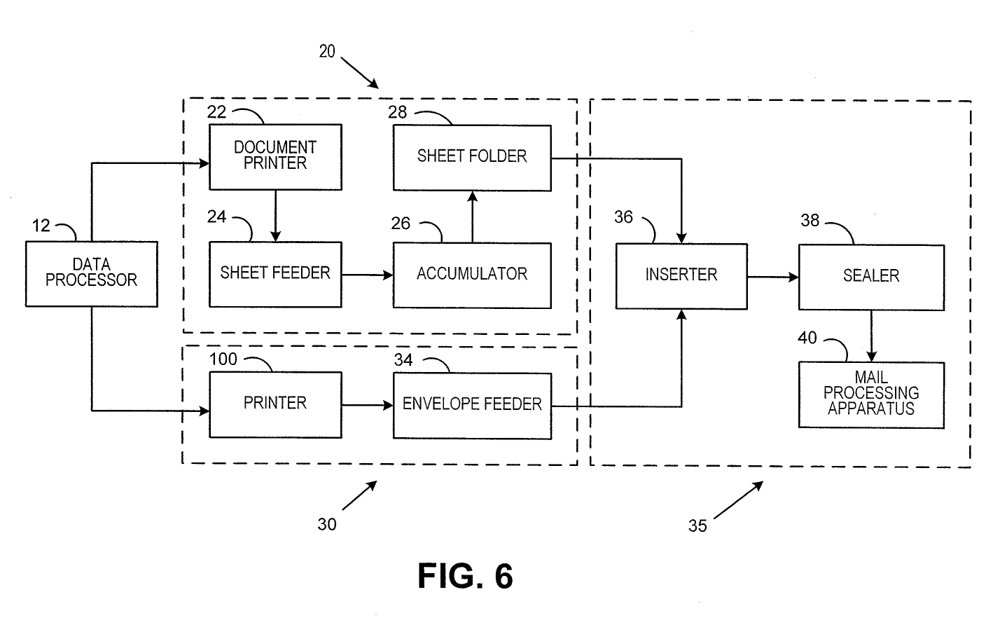

FIG. 6 is a system diagram showing printer 100 of FIG. 1 being coupled to an inserter. Subsystem 20 is comprised of: document printer 22 which prints document data obtained from data processor 12, to a substrate or media, such as a standard cut sheet; sheet feeder 24, which directs the printed substrate or sheet to an accumulator; accumulator 26, which collects the individual sheets to be folded together by a sheet folder; and, sheet folder 28, which folds together the individual sheets to be inserted in each envelope.

Subsystem 30 comprises the elements which support the addressing data stream. Subsystem 30 is comprised of printer 100, which prints addressing data (the addressing data may include recipient and sender data) obtained from data processor 12, to a substrate such as an envelope; and, envelope feeder 34, which directs the printed envelope to an inserter.

Subsystem 35, which comprises mailpiece processing apparatus, reunites the divided data streams by inserting the folded and addressed sheets into their corresponding addressed envelopes. The elements of subsystem 35 include inserter 36, which places the folded sheets coming from sheet folder 28 into the envelopes coming from envelope feeder 34. The stuffed envelopes are then passed from inserter 36 to sealer 38, where the envelopes are sealed before being finished by mail processing apparatus 40. The mail processing apparatus can be diverse in that the apparatus might include: another inserter (if the sealed envelope was being further inserted into another envelope); a mailing scale; a postage meter; and tabbing devices, among other possible elements. A key element of the overall system is the timing of the two data streams so as to properly match the printed document with its respective printed envelope.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A method comprising:
printing a return address on a mail piece;
printing a destination address on the mail piece,
wherein the return address is printed by a first print head assembly and the destination address is printed by a second print head assembly, wherein at least part of the return address being printed simultaneously with at least part of the destination address, wherein the first print head assembly prints in a first direction and the second print head assembly prints in a second direction.

2. The method claimed in claim 1, wherein the first direction is opposite of the second direction.

3. The method of claim 1, further comprising:
pulling the first print head assembly in the first direction by using a drive belt wound around a first pulley and a second pulley while guiding the first print head assembly with a first guide shaft; and
pulling the second print head assembly in the second direction by using the drive belt wound around the first pulley and the second pulley while guiding the second print head assembly with a second guide shaft.

4. The method of claim 3, wherein the first print head assembly comprises a first print cartridge and a third print cartridge that is offset from the first print cartridge.

5. The method of claim 3, wherein the second print head assembly comprises a second print cartridge and a fourth print cartridge that is offset from the second print cartridge.

6. The method of claim 1, further comprising:
printing a postage indicia on the mail piece via the first print head assembly, wherein the postage indicia is printed simultaneously with at least part of the destination address.

7. The method of claim 1, wherein the return address is printed in an upper left quadrant of a front face of the mail piece.

8. The method of claim 1, wherein the destination address is printed at least in part in a lower right quadrant of a front face of the mail piece.

9. A printer comprising:
a first pulley;
a second pulley;
a first guide shaft;
a second guide shaft;
a drive belt coupled to the first pulley and the second pulley and pulled by the second pulley;
a first print head assembly for printing in a first direction comprising:
a first print head;
a first print cartridge coupled to the first print head to supply ink to the first print head;
a first guide shaft coupling to couple the first print head assembly to the first guide shaft; and
a first drive belt coupling to couple the first print head assembly to the drive belt;
a second print head assembly for printing in a second direction comprising:
a second print head;
a second print cartridge coupled to the second print head to supply ink to the second print head;
a second guide shaft coupling to loosely couple the second print head assembly to the second guide shaft; and
a second drive belt coupling to couple the second print head assembly to the drive belt,
wherein the drive belt forming a loop when coupled to the first pulley and the second pulley, wherein the first print head assembly is coupled to a first portion of the loop, wherein the second print head assembly is coupled to a second portion of the loop, and wherein when the drive belt is pulled, the first print head assembly is moved in the first direction and the second print head assembly is moved in the second direction, the second direction opposite the first direction.

10. The printer of claim 9, wherein the first print head assembly comprises a third print cartridge that is offset from the first print cartridge.

11. The printer of claim 9, wherein the second print head assembly comprises a fourth print cartridge that is offset from the second print cartridge.

12. The printer of claim 9, wherein a return address is printed by the first print head assembly and the destination address is printed by the second print head assembly, and wherein at least part of the return address being printed simultaneously with at least part of the destination address.

13. The printer of claim 9, further comprising:
a first print buffer for storing information to be printed by the first print cartridge; and
a second print buffer for storing information to be printed by the second print cartridge.

14. The printer of claim 9, further comprising:
an envelope feeder for feeding envelopes seriatim to the first and second print cartridges.

15. The printer of claim 14, wherein the envelope feeder feeds at least 10,000 envelopes per hour.

16. A system comprising:
a first print head assembly that prints a return address on a mail piece;
a second print head assembly that prints a destination address on the mail piece, wherein the return address is printed by the first print head assembly and the destination address is printed by the second print head assembly, wherein at least part of the return address being printed simultaneously with at least part of the destination address, wherein the first print head assembly prints in a first direction and the second print head assembly prints in a second direction.

17. The system claimed in claim 16, wherein the first direction is opposite of the second direction.

18. The system of claim 16, further comprising:
a drive belt wound around a first pulley and a second pulley while guiding the first print head assembly with a first guide shaft the first print head assembly is pulled in the first direction; and
the drive belt wound around the first pulley and the second pulley while guiding the second print head assembly with a second guide shaft the second print head assembly is pulled in the second direction.

19. The system of claim 17, wherein the first print head assembly comprises a first print cartridge and a third print cartridge that is offset from the first print cartridge.

20. The system of claim 17, wherein the second print head assembly comprises a second print cartridge and a fourth print cartridge that is offset from the second print cartridge.

21. The system of claim 17, further comprising:
means for printing a postage indicia on the mail piece via the first print head assembly, wherein the postage indicia is printed simultaneously with at least part of the destination address.

22. The system of claim 17, wherein the return address is printed in an upper left quadrant of a front face of the mail piece.

23. The system of claim 17, wherein the destination address is printed at least in part in a lower right quadrant of a front face of the mail piece.

24. The system of claim 16, further comprising;
a inserter coupled to the first and second print heads so that media may be inserted into the mail piece.
